(19) United States
(12) Patent Application Publication
(10) Pub. No.: US 2022/0327551 A1
(43) Pub. Date: Oct. 13, 2022

(54) SYSTEM AND METHOD FOR DETERMINING AND EXECUTING USAGE- BASED TRANSACTIONS USING SMART CONTRACTS AND DISTRIBUTED LEDGER ARRANGEMENTS

(71) Applicant: Frank TIETZE, Cambridge (GB)

(72) Inventors: Frank TIETZE, Cambridge (GB); Damiano DI FRANCESCO MAESA, Gambassi Terme (IT)

(21) Appl. No.: 17/640,454

(22) PCT Filed: Sep. 4, 2020
(86) PCT No.: PCT/IB2020/058253

§ 371 Date: Mar. 4, 2022

(30) Foreign Application Priority Data
Sep. 4, 2019 (GB) 1912738.0

(51) Int. Cl. G06Q 30/00

(52) U.S. Cl. CPC G06Q 30/018

(57) ABSTRACT

Disclosed is a system for determining usage-based transactions from at least one licensee to at least one licensor using smart contracts and at least one electronic commodity in a distributed ledger arrangement. A server arrangement is operable to receive at least a first usage information of an electronic commodity associated with a licensee, store the usage information in the distributed ledger arrangement, identify at least one smart contract relating to the commodity comprising licensing information and terms relating to usage of the commodity from the distributed ledger arrangement, trigger at least one smart contract based on the usage information stored in the distributed ledger arrangement to determine the usage-based transactions, to be executed, and provide information related to the usage-based transactions on at least one licensee device and at least one licensor device.

### TECHNICAL FIELD

The present disclosure relates generally to licensing operations for electronic devices in various IoT associated industries or sectors; and more specifically, to systems and methods for executing licensing markets on distributed ledger arrangements for connected devices.

### BACKGROUND

With furtherance in research and development of electronic and connected devices, progressive developments are made across different IoT related technologies. Such technological developments require time, energy and efforts of inventors and/or developers. Therefore, inventors are granted legal rights (for example, intellectual property rights) over technological developments accomplished thereby. Moreover, laws are enforced to protect such legal rights of the creators for better identification, planning, commercialization, and rendering of such technological developments.

Typically, an inventor holding legal rights over a technology may provide licenses to entities for commercializing (for example, make, use, sell, import, offer to sell, and so forth) the said technology, with adherence to an agreement of licensing. In this regard, technology licensing and developing agreements are increasingly important for efficient and smooth operation, and further growth of businesses and industries. Essentially, manufacturing of a device requires a manufacturer to assemble and aggregate a plurality of components, functionalities and Intellectual property from multiple sources (namely, multiple licensors).

Therefore, efficient and accurate licensing (enabling markets, agreements of licensing) have become indispensable owing to interactions of a licensor with multiple licensees, multiple licensors with a licensee and multiple licensees with multiple licensors. Such licensing ensure payments of licensing fees to the inventor (namely, licensor) by users (namely, licensee) of the technology.

However, such licensing markets, typically run by agents, have to manually assemble information relating to licensing agreements for the manufacturer (namely, licensee) with multiple licensors. Essentially, licensees face transaction costs for collecting relevant data (such as, number of units produced, a number of sales, and so forth) to make payments to licensor(s). Such payments to licensor(s) become more challenging in case multiple products, each product having multiple licensors, and each licensor having different agreement of licensing. Similarly, agents have to manually assemble information relating to multiple licensing agreements for a licensor with multiple licensees. In this regard, licensors face challenges to verify licensing fees from multiple licensees based on different agreements of licensing with the multiple licensees. Additionally, verifying correctness of received licensing fees by the licensors, from multiple licensees, is difficult owing to limited insights into relevant data for calculating the licensing fees owing to the often-sensitive nature of such relevant data.

Subsequently, there is limited transparency in regard to calculation of licensing fee for a licensor. Moreover, a lot of manual effort is utilized for such manual or semi-manual accumulation of relevant data and further processing thereof for determination of licensing fees to be paid by a licensee to licensor(s). Moreover, such a process is made more complicated owing to the changing nature of agreement of licensing.

Moreover, the predominant approach for licensing markets for calculating licensing fees and verifying correctness thereof is still semi-manual, resource intensive and inefficient, thus prone to errors, uncertainties and unreliable. Additionally, the semi-manual nature of licensing market impacts terms of licensing agreements thereby impelling both licensor and licensee to agree to simple and doable terms of licensing agreement, which however might not be optimal.

Therefore, in light of the foregoing discussion, there exists a need to overcome the aforementioned drawbacks associated with the conventional systems for implementing licensing markets.

### SUMMARY

The present disclosure seeks to provide a system for determining and executing usage-based transactions from at least one licensee to at least one licensor using smart contracts and distributed ledger arrangements. The present disclosure also seeks to provide a method for determining usage-based transactions from at least one licensee to at least one licensor using a distributed ledger arrangement. The present disclosure seeks to provide a solution to the existing problem of time and labour intensive, manual or semi-manual methods and often low accuracy, for calculation and executing of licensing fees to be provided to licensor(s) from licensees. An aim of the present disclosure is to provide a solution that overcomes at least partially the problems encountered in prior art, and provides a system that employs smart contracts and distributed ledgers to track usage of commodities and automatically and more accurately than what prior art suggests to calculate licensing fees based thereon.

In one aspect, an embodiment of the present disclosure provides a system for determining usage-based transactions from at least one licensee to at least one licensor using smart contracts and a distributed ledger arrangement, wherein the system comprises at least one electronic commodity, a server arrangement communicably coupled to the distributed ledger arrangement, the server arrangement operable to:
receive at least a first usage information of a commodity associated with the licensee;
store the usage information in the distributed ledger arrangement;
identify at least one smart contract relating to the commodity from the distributed ledger arrangement, wherein the smart contracts comprise licensing information and terms relating to usage of the commodity;
trigger at least one smart contract based on the usage information stored in the distributed ledger arrangement to determine the usage-based transactions, to be executed; and
provide information related to the usage-based transactions on at least one licensee device and at least one licensor device.

In another aspect, an embodiment of the present disclosure provides a method for determining usage-based transactions from at least one licensee to at least one licensor using smart contracts and a distributed ledger arrangement, wherein the method is implemented via a system comprising at least on electronic commodity, a server arrangement communicably coupled to the distributed ledger arrangement. The method comprising:
receiving at least a first usage information of a commodity associated with the licensee;
storing the usage information in the distributed ledger arrangement;
identifying at least one smart contract relating to the commodity from the distributed ledger arrangement, wherein the smart contracts comprise licensing information and terms relating to usage of the commodity;
triggering at least one smart contract based on the first usage information stored in the distributed ledger arrangement for determining the usage-based transactions, to be executed; and
providing information related to the usage-based transactions on at least one licensee device and at least one licensor device.

In yet another aspect, an embodiment of the present disclosure provides a computer program product comprising non-transitory computer-readable storage media having computer-readable instructions stored thereon, the computer-readable instructions being executable by a computerized device comprising processing hardware to execute aforesaid method.

Embodiments of the present disclosure substantially eliminate or at least partially address the aforementioned problems in the prior art, and enable automated calculation, and further transactions relating to licensing fees to be provided by at least one licensee to at least one licensor thereby eliminating manual effort in tracking of commodity and enhancing transparency and reliability for the licensee(s) and the licensor(s).

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an architecture implementing system for determining and executing usage-based transactions from at least one licensee to at least one licensor using smart contracts and a distributed ledger arrangement, in accordance with an embodiment of the present disclosure; and

FIG. 2 illustrates steps of a method for determining and executing usage-based transactions from at least one licensee to at least one licensor using smart contracts and a distributed ledger arrangement, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a system for determining and executing usage-based transactions from at least one licensee to at least one licensor using smart contracts and a distributed ledger arrangement, wherein the system comprises at least one electronic commodity, a server arrangement communicably coupled to the distributed ledger arrangement, the server arrangement operable to:
receive at least a first usage information of a commodity associated with the licensee;
store the usage information in the distributed ledger arrangement;
identify at least one smart contract relating to the commodity from the distributed ledger arrangement, wherein the smart contracts comprise licensing information and terms relating to usage of the commodity;
trigger at least one smart contract based on the first usage information stored in the distributed ledger arrangement to determine the usage-based transactions, to be executed; and
provide information related to the usage-based transactions on at least one licensee device and at least one licensor device.

In another aspect, an embodiment of the present disclosure provides a method for determining usage-based transactions from at least one licensee to at least one licensor using smart contracts and a distributed ledger arrangement, wherein the method is implemented via a system comprising at least one electronic commodity, a server arrangement communicably coupled to the distributed ledger arrangement. The method comprising:
receiving at least a first usage information of a commodity associated with the licensee;
storing the usage information in the distributed ledger arrangement;
identifying at least one smart contract relating to the commodity from the distributed ledger arrangement, wherein the smart contracts comprise licensing information and terms relating to usage of the commodity;
triggering at least one smart contract based on the first usage information stored in the distributed ledger arrangement for determining the usage-based transactions, to be executed; and
providing information related to the usage-based transactions on at least one licensee device and at least one licensor device.

In yet another aspect, an embodiment of the present disclosure provides a computer program product comprising non-transitory computer-readable storage media having computer-readable instructions stored thereon, the computer-readable instructions being executable by a computerized device comprising processing hardware to execute aforesaid method.

The system for determining usage-based transactions from at least one licensee to at least one licensor using smart contracts and a distributed ledger arrangement as described in the present disclosure provides a trust-worthy, traceable and tamper-proof platform for implementing and enforcing licensing agreements. Notably, the system enables licensors and licensees to store licensing agreements associated therewith, in the distributed ledger arrangement. Moreover, the system triggers smart contracts for operation, when needed. Pursuant to embodiments of the present disclosure, a smart contract is triggered when a commodity is used. Specifically, once the smart contract is triggered, an accurate licensing fee is provided from a licensee to licensors. Beneficially, the system executes licensing transactions to provide licensing fees from at least one licensee to at least one licensor, at a time, based on licensing agreements potentially specific to each of licensor. Henceforth, the licensee does not need to compile potentially complex data (for example, units sold across various countries for a commodity and variants of the commodity) through a semi-manual process and then calculate corresponding licensing fees for the at least one licensor. Alternatively, activation (namely, usage) of a commodity allows the system to trigger precise and accurate licensing transactions associated with the commodity.

Moreover, the system reduces transaction cost associated with licensing transactions for licensees as well as licensors owing to reduced manual labour required for maintenance and auditing of complex data associated with licensing transactions. Additionally, the system performs the licensing transactions in an accurate and secure manner thereby preventing security threats and unauthorized access to such transactions. Furthermore, the licensees do not need to disclose sensitive data (for example, number of units of commodity manufactured, number of units of commodity sold, and the like) to other users of the system or licensors for operation of the system. Hence, the system reduces consequences from information asymmetries and trust problems by substituting current semi-manual systems with an automated and trustworthy system. Alternatively, the system automatically executes the licensing transactions when the commodity is used, thereby enabling efficient and accurate accounting for licensing transactions for the licensees and the licensors.

Beneficially, the system determines and automatically executes accurate licensing transactions thereby enabling proper remuneration of inventive activities for the licensors. Specifically, the system accurately determines licensing fees by matching commodity information with licensed assets (namely, licensing information) embedded therein, wherein such information is stored in smart contracts associated with the commodity. Furthermore, the system executes licensing transactions for licensed assets associated with the commodity to licensors of the licensed assets, using distributed ledger arrangements and smart contracts associated with the commodity.

Furthermore, the system enables new business models that are currently impossible owing to the complex and costly nature of current systems for determination of usage-based royalty payments (licensing fees). Subsequently, the disclosed system may enable adapting of more efficient licensing models than those currently employed, often simplified to reduce complex calculations. The system calculates licensing fees for licensors based on any nature of licensing agreement that enable licensors and licensees of commodities to benefit in a fairer and more optimal way rather than agreeing to simple and often sub-optimal payments (e.g. lump sums).

Thus, the system leads to more transparency, automation, efficiency and accuracy in licensing markets and/or licensing value-chains, and further allows smaller businesses to participate in those with greater control and at reasonable costs.

Pursuant to embodiments of the present disclosure, the system and method disclosed herein enable efficient and reliable transactions relating to licensed commodities between licensors and licensees. Notably the present disclosure substantially eliminates a need for manual intervention in the licensing payment process, wherein the licensors and licensees agree on licensing information and terms that are thereafter executed by the distributed ledger arrangement. Beneficially, the present disclosure ensures a secure and confidential determination of usage-based transactions while ensuring traceability thereof.

Throughout the present disclosure, the term “electronic commodity” refers to a technical product with some kind of wired or wireless connectivity feature, such as Bluetooth, wireless lan, etc or other technically inventive works for which the licensor owns exclusive rights for making, using and selling. Notably, since the licensor owns exclusive rights over the electronic commodity, the licensor may provide a license to licensees for making, using and/or selling the commodity. Subsequently, the licensee agrees to provide an agreed return (such as, monetary compensation) to the licensor in exchange of the license. In an example, the licensor owns a patent for a commodity such as a network connected device. Consequently, the licensor may license the rights for manufacture and use of the commodity to a licensee. It will be appreciated that the agreed returns to the licensors from the licensees are outlined in a legal document comprising licensing information and terms. Such legal document enforced between the licensor and licensee includes agreement terms relating to use and manufacture of the commodity, such as monetary compensation (namely, a royalty) provided by the licensee, terms of manufacturing of the commodity, geographical areas for selling the commodity and so forth. In an example, the licensee may agree to pay the licensor the monetary compensation for every unit of commodity manufactured or sold by the licensee. In another example, the licensee may agree to pay the licensor the monetary compensation for every year of owning the license. Other examples of commodity, include, but are not limited to IOT implemented thermostats, lights, locks, appliances; IP cameras; drones; voice controllers etc.

The system for determining usage-based transactions from a licensee to at least one licensor uses the distributed ledger arrangement. Herein, the term “distributed ledger arrangement” refers to a ledger (such as a database) comprising entries recording operations and/or contracts, with a timestamp. Pursuant to embodiments of the present disclosure, the distributed ledger arrangement refers to a database of the entries, wherein the entries comprise the operation records therein. Moreover, the distributed ledger arrangement is consensually shared and synchronised in a tamper resistant and decentralised form across the plurality of computing nodes. In this regard, the ledger is consensually shared and synchronised across multiple sites, institutions or geographies. Optionally, such computing nodes are established across different locations and operated by different users. Beneficially, the distributed ledger arrangement eliminates the need of a central authority to maintain the distributed ledger arrangement and protect it against manipulation. Specifically, the entries comprising the operation records in the distributed ledger arrangement are monitored publicly, thereby making the distributed ledger arrangement robust against attacks.

It will be appreciated that the plurality of computing nodes (namely, peers) in the distributed ledger arrangement may access each of the entries in the distributed ledger arrangement and may own an identical copy of each of the entries. Notably, an alteration made to the distributed ledger arrangement is reflected almost instantly to each of the plurality of computing nodes. Subsequently, an addition of an entry (such as recordal of an entry in the distributed ledger arrangement) is completed when all or some of the plurality of computing nodes perform a validation with respect to the addition. In such case, the entry is recorded (namely, added) in the distributed ledger arrangement in an immutable form when at least a threshold number of computing nodes from the plurality of computing nodes reach a consensus that the entry is valid. Alternatively, recording of the entry is denied when the threshold number of computing nodes reach a consensus that the entry is invalid. In an example, the threshold number of computing nodes to reach a consensus may be fifty per cent plus one (50%+1) of the plurality of computing nodes. Optionally, information in the distributed ledger arrangement is stored securely using cryptography techniques. Beneficially, the distributed ledger arrangement allows reliable and transparent recordal of the entries, in that the operation records (for example, exchange of a technical resource over the data communication network) are permanently recorded and may not be capable of alterations. Thus, the distributed ledger arrangement provides greater transparency, enhanced security, improved traceability, increased efficiency and speed of operations.

The system comprises a server arrangement communicably coupled to the distributed ledger arrangement. Herein, the term “server arrangement” refers to a structure and/or module that include programmable and/or non-programmable components configured to store, process and/or share information. Optionally, the server includes any arrangement of physical or virtual computational entities capable of enhancing information to perform various computational tasks. Furthermore, it should be appreciated that the server may be both a single hardware server and/or plurality of hardware servers operating in a parallel or distributed architecture. In an example, the server may include components such as memory, a processor, a network adapter and the like, to store, process and/or share information with other computing components, such as user device/user equipment. Optionally, the server is implemented as a computer program that provides various services (such as database service) to other devices, modules or apparatus. Furthermore, the server arrangement is communicably coupled to the distributed ledger arrangement in a manner that the server arrangement is capable of storing information as entries in the distributed ledger arrangement.

It will be appreciated that the present disclosure relates to determining (namely, calculating) and executing usage-based transactions (for example, such as monetary compensations) that are to be made automatically by at least one licensee to at least one licensor for licensing a commodity. Notably, determining usage-based transactions can be a tedious task if performed manually and has a high risk of miscalculation. Therefore, the present disclosure provides a system that automatically determines and executes highly accurate transactions from at least one licensee to at least one licensor based on the usage of the commodity. For instance, a licensee may have licensed the commodity from at least one licensor and may be manufacturing a plurality of units of such commodity for sale. Consequently, the licensee has to perform a transaction for every unit of commodity manufactured, sold and/or used. Therefore, the system of the present disclosure tracks usage of each of the commodities to determine the usage-based transactions the licensee has to perform towards at least one licensor.

The server arrangement is operable to receive at least a first usage information of a commodity. The usage information refers to the information indicating a first use of the commodity. Specifically, the server arrangement receives usage information that indicates at least the first use of the commodity. In an instance, the first usage information is provided using the commodity, discussed in detail herein later. In another instance, the licensee provides usage information of the commodity to the server arrangement. In yet another instance, the owner of the commodity (such as, the person purchasing the commodity from the licensee) provides the usage information to the server arrangement.

In an exemplary implementation, the commodity is a mobile and network connected device. Notably, this device is capable of transmitting and receiving signals. Therefore, at an instance when the device is booted (namely, turned on) for the first time, the mobile device is configured to send the first usage information to the server arrangement. Alternatively, verification of a license code of the mobile device may be interpreted as a first usage signal and consequently, upon receiving a request for verification of the license code by the licensee, the licensee may communicate the first usage information to the server arrangement. The device may then send further usage information when being used.

The server arrangement is operable to store at least the first usage information in the distributed ledger arrangement. As mentioned previously, the distributed ledger arrangement stores records, data and information as entries with a timestamp therein. Therefore, the server arrangement receives at least the first usage information and adds an entry each in the distributed ledger arrangement, thereby storing the usage information in the distributed ledger arrangement. The usage information may comprise information relating to the identification of the commodity, for example, the serial number or the identification number of the commodity.

Optionally, the distributed ledger arrangement is implemented by way of a blockchain platform. Notably, the distributed ledger arrangement refers to the blockchain platform that is configured to store a plurality of records. More specifically, in the blockchain platform, each record stores a cryptographic hash of a previous record, new information stored in the record and a timestamp associated with the record. Furthermore, the distributed ledger arrangement, specifically, the blockchain platform is managed by a peer-to-peer network collectively adhering to a protocol for inter-record communication and validation of new records . Thus, storing at least the first usage information in the distributed ledger arrangement provides an immutable record with an associated timestamp.

The server arrangement is further operable to identify at least one smart contract relating to the commodity, from the distributed ledger arrangement. Specifically, prior to the first use of a commodity, at least one smart contract is stored as an entry in the distributed ledger arrangement. As aforementioned, the usage information comprises information relating to the identification of the commodity. Therefore, by using such information, at least one smart contract relating to the commodity is identified from the distributed ledger arrangement. The smart contracts comprise licensing information and terms relating to the usage of the commodity. As aforementioned, the agreed returns (such as the monetary compensation) to the licensor from the licensee are outlined in legal documents comprising licensing information and terms. Consequently, such licensing information and terms are encoded from the legal document into at least one smart contract relating to the commodity.

Throughout the present disclosure, the term “smart contract” refers to a computer protocol implemented using the distributed ledger arrangement comprising licensing information and terms relating to the commodity. Moreover, smart contracts permit trusted execution thereof without involving a central authority, legal system, or externally enforced mechanisms. Furthermore, the licensing information and conditions refer to two tiers of information. Specifically, the first of the two tiers of information relates to licensing information and specifically, to ownership rights of the licensor. More specifically, the first of the two tiers of information outlines ownership rights held by the licensor in the commodity. Notably, in an instance, when the commodity comprises components of one or more licensors, the licensing information details components corresponding to one or more licensors. Moreover, the second of the two tiers of information relates to monetary compensation owed to the one or more licensors for making, using and/or selling the commodity. Therefore, the licensing information and terms provide, in detail, the components owned by the one or more licensors in the commodity and also, the monetary compensation owed to the one or more licensors by the licensee.

Optionally, the smart contracts are stored in the distributed ledger arrangement upon receiving approval, relating to licensing information and terms, from relevant licensees and licensors. Specifically, the legal document comprising licensing information and terms is agreed upon by the licensee and licensor. It will be appreciated that such legal documents comprising licensing details and information relating to monetary compensation are enforced as legal contracts between two parties and thus, have to be agreed upon by the licensor and at least one licensee. Therefore, after such legal document is encoded as at least one smart contract relating to the commodity, such smart contract(s) is provided to the licensee(s) and the licensor(s) or another agent for review and approval. Subsequently, upon receiving approval of the smart contract(s) from licensee(s) and licensor(s), the smart contract(s) is added as an entry to the distributed ledger arrangement by the server arrangement.

The server arrangement is operable to trigger the smart contracts based on the usage information stored in the distributed ledger arrangement to determine the usage-based transactions to be executed. Notably, the smart contract is triggered on the condition that the commodity has been put to use, indicated by the usage information. It will be appreciated that the entry in the distributed ledger arrangement storing at least the first usage information functions as a proof of fulfilment of the condition required for triggering the smart contract. As aforementioned, the smart contract comprises licensing information and terms relating to the usage of the commodity. Therefore, usage-based transactions are determined based on such licensing information and terms. Herein, the term “usage-based transaction” refers to a transferral of compensation (for example, the monetary compensation) from the licensee to the licensor, wherein the compensation is dependent upon usage of the license for the commodity. In other words, if the licensee uses the license provided by the licensor for making, using and/or selling ‘n’ number of units of the commodity, the licensee is liable to provide compensation to the licensor for ‘n’ number of usage based-transactions. In an example, the licensee has agreed to pay a compensation of one dollar for every unit of commodity manufactured, sold and/or used. Herein in the example, the licensee manufactures a 100 units of the commodity. Consequently, for every first usage information received from one of the 100 units, the smart contract is triggered and one dollar is determined as a usage-based transaction to be executed (namely, paid) from the licensee to the licensor. Transactions can be triggered separately or can be aggregated so that the licensor would not receive 100 transactions of one dollar but one transaction of 100 dollar.

Optionally, the commodity is an electronic device. Examples of electronic devices include, but are not limited to, network connected internet-of-things sensors, cellular phones, personal digital assistants (PDAs), handheld devices, wireless modems, laptop computers, personal computers, network printers, connected household appliances etc. Notably, electronic devices generally include at least a casing, a memory, a processor, a network interface. It will be appreciated that a commodity such as an electronic device is manufactured using intellectual properties owned by a plurality of licensors. Specifically, an electronic device such as a cellular phone may comprise one or more components such as a processor licensed by a first licensor, a display screen licensed by a second licensor, a memory chipset licensed by a third licensor and so forth. Consequently, for every commodity of such nature manufactured, used or sold by the licensee, the licensee has to provide compensation (namely, royalty) to each of the plurality of licensors whose intellectual properties have been used to manufacture said commodity. Therefore, for first usage information received from every commodity of such nature, a plurality of usage-based transactions are to be executed towards the plurality of licensors. Notably, a single or multiple smart contracts, once triggered, determine such usage-based transactions to be executed towards the plurality of licensors.

More optionally, the server arrangement is operable to receive usage information of one or more components of the electronic device upon use thereof and execute a secondary smart contract relating to the one or more components. It will be appreciated that one or more components of the electronic device may be subjected to use sparingly. Therefore, monetary compensations to licensors of such one or more components may not be lumped with the usage of the electronic device, as usage of the electronic device does not necessitate usage of such one or more components. Consequently, compensation is provided to licensors of such one or more components only upon usage of such one or more components. In an example, such one or more components may include Bluetooth® communication interface, heart-rate sensor, Near-Field Communication (NFC) interface and so forth. Therefore, the electronic device transmits usage information of such one or more components upon usage thereof. The distributed ledger arrangement may comprise secondary smart contracts for such one or more components, wherein usage-based transactions of such one or more components are determined upon triggering the smart contracts.

The server arrangement is operable to provide information related to usage-based transactions on at least one licensee device and at least one licensor device. Specifically, the licensee and the at least one licensor have computing devices (such as, a cellular phone) associated therewith, herein referred to as the licensee device and the at least one licensor device. Furthermore, the licensee device and at least one licensor device may act as peer nodes in the distributed ledger arrangement. It will be appreciated that the usage-based transactions reflect data relating to sale or use of the commodity. Consequently, the licensee may not wish to share such confidential data with at least one licensor. Therefore, an aggregated data related to the usage of the commodity and corresponding compensation owed to the at least one licensor are provided on the at least one licensor device. Alternatively, the total amount owed by the licensee to the at least one licensor is provided on the at least one licensor device, whereas the licensee device is provided with complete information relating to the usage-based transactions.

Optionally, the server arrangement executes the usage-based transactions on the licensee device and at least one licensor device. Notably, executing the usage-based transactions refers to transferral of monetary compensations from the licensee to the at least one licensor. Specifically, the server arrangement is integrated with a payment gateway protocol, wherein payment account details of licensee and at least one licensor are input therein. Consequently, the server arrangement upon triggering of the smart contract determines the usage-based transactions and executes to respective parties.

Optionally, the server arrangement is communicably coupled with a licensee database arrangement. Notably, the licensee database arrangement is a private database, only accessible to entities authorised by the licensee. Therefore, the information related to usage-based transactions may only be provided to the licensee device and thereafter stored in the licensee database arrangement. Furthermore, a cryptographic hash or zero knowledge proof of the usage-based transaction is shared with the at least one licensor device using the server arrangement, wherein such cryptographic proof can be used for validation and auditing of the usage-based transactions while concealing confidential information relating to the usage and sale of the commodity.

Optionally, the server arrangement and/or the licensee device are employed to validate the entry comprising first usage information stored in the distributed ledger arrangement.

More optionally, the server arrangement includes a module to allow communication of external data to the distributed ledger arrangement as a way to store information in it. Depending on the distributed ledger arrangement employed such a module could be implemented via an oracle maintained by the server arrangement. Oracles allow for external information pushing in closed distributed ledger arrangement systems.

Optionally, the distributed ledger arrangement is a private/permissioned distributed ledger arrangement. Notably, public distributed ledger arrangements (for example, such as Ethereum) are accessible to public entities having no stakes in the licensing process. Such public access to the distributed ledger arrangement may significantly affect the security and confidentiality of the system. Therefore, the system can employ a private distributed ledger arrangement that is only accessible to authorised parties. In an alternative embodiment the smart contract system is implemented without the use of a distributed ledger system. This could be in a P2P storage such a SAFENework by Maidsafe®. Such authorisation for access to the distributed ledger arrangement is provided by the licensee (using the licensee device), the licensor or the operator of the server arrangement.

Optionally, the distributed ledger arrangement is implemented by way of Hyperledger Fabric. Notably, Hyperledger Fabric is a permissioned network, wherein the entities accessing the network are pre-authorised. Furthermore, Hyperledger Fabric's identity service is based on X.509(RFC5280 protocol for Public Key Infrastructure Certificate). Furthermore, operations of the Hyperledger Fabric (such as triggering of the smart contract) are executed using chaincodes employed therein.

Moreover, the present description also relates to the method as described above. The various embodiments and variants disclosed above apply mutatis mutandis to the method.

Optionally, the method comprises executing the usage-based transactions on the licensee device and at least one licensor device.

Optionally, the method comprises storing the smart contracts in the distributed ledger arrangement upon receiving approval, relating to licensing information and terms, from the licensee and at least one licensor.

Optionally, the commodity is an electronic device.

More optionally, the method comprises receiving usage information of one or more components of the electronic device upon use thereof and executing a secondary smart contract relating to the one or more components.

Optionally, the distributed ledger arrangement is a private distributed ledger arrangement.

For illustration purposes only, there will now be discussed an example illustration, wherein a licensee is manufacturing a new sensor with a hardware module (the commodity) licensed by a unique licensor. The licensor agrees to reduce its initial higher lump sum payment desired for a more flexible usage-based model with royalties dependent on the actual usage during a device life of the considered hardware module.

The licensor and licensee agree to a licensing agreement that rewards the licensor with an initial lump sum of one USD per activated device plus a royalty of 0.01 USD per each use of the hardware module after activation. The payments are to be computed and made at the end of month.

The server arrangement is configured to deploy and maintain a software module embedded in each manufactured device to forward to such server activation and usage information, as well as a local (private) database keeping track of such received information. The server arrangement is also configured to include an oracle type smart contract deployed on the distributed ledger arrangement of choice, and a tool to compile and deploy further smart contracts.

Once the licensing agreement is agreed upon by both licensor and licensee, a software module of the server arrangement is employed to translate the legal document into a single representing smart contract to be deployed on the distributed ledger arrangement. Such contract is first checked and verified by both the licensor and licensee and then deployed signed by the server arrangement. The smart contract is a coded representation of the logic of the licensing agreement so it contains instructions to query the server arrangement maintained oracle for updated data on activations and usage of the licensed commodity. Upon receiving such data it updates its internal records by computing the new owed royalty by crediting the licensor one USD for each new device activated and 0.01 USD for each usage of the commodity.

The licensee is tasked to keep the oracle data up to date through the server arrangement. In fact, once a device is activated or used it will send such information to the server arrangement that then batches together all such data at regular intervals of time and updates the oracle information accordingly.

At the end of each month the licensor device can query the contract to find out how much it is owned, and it can use the contract information to reset the royalty computation fresh for the new month and initiate an usage-based transaction with the correct, automatically computed royalty value. As the entire process is automated on both the Licensor and Licensee sides through the server arrangement updates (e.g. the device communication and oracle management) and the distributed ledger arrangement automatic and tamper resistant execution of smart contracts, the system is more trustworthy and less complex for both parties involved.

### DETAILED DESCRIPTION OF THE DRAWINGS

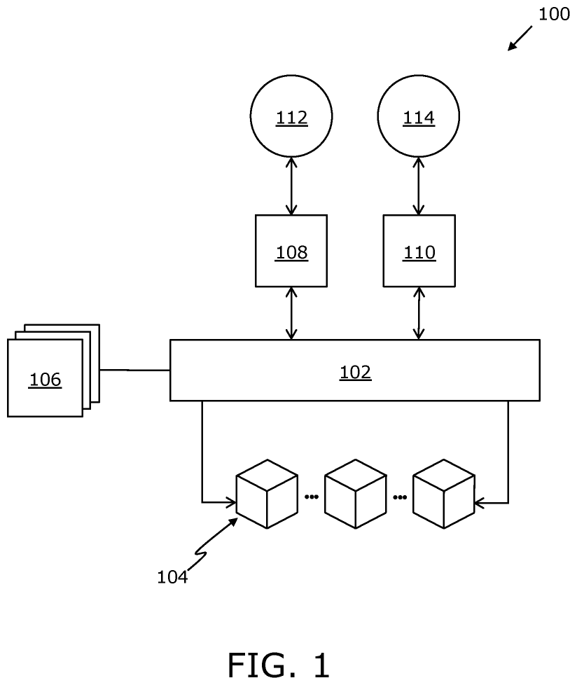

Referring to FIG. 1, there is shown a schematic illustration of an architecture implementing system 100 for determining and executing usage-based transactions from at least one licensee 114 to at least one licensor (depicted as a licensor 112) using smart contracts and a distributed ledger arrangement 104, in accordance with an embodiment of the present disclosure. The system 100 comprises a server arrangement 102 communicably coupled to the distributed ledger arrangement 104. The server arrangement 102 is operable to receive at least a first usage information of a commodity 106 associated with the licensee 114, store the first usage information in the distributed ledger arrangement 104 and identify at least one smart contract (not shown) relating to the commodity 106 from the distributed ledger arrangement 104, wherein the smart contract comprises licensing information and terms relating to usage of the commodity 106. The server arrangement 102 is operable to trigger the smart contract based on the first usage information stored in the distributed ledger arrangement 104 to determine the usage-based transactions, to be executed and provide information related to the usage-based transactions on at least one licensee device 110 and at least one licensor device (depicted as licensor device 108).

FIG. 1 is merely an example, which should not unduly limit the scope of the claims herein. It is to be understood that the simplified illustration of the system 100 for determining usage-based transactions from at last one licensee to at least one licensor using smart contracts and a distributed ledger arrangement, is provided as an example and is not to be construed as limiting the system 100 to specific numbers, types, or arrangements of the processing arrangement. A person skilled in the art will recognize many variations, alternatives, and modifications of embodiments of the present disclosure.

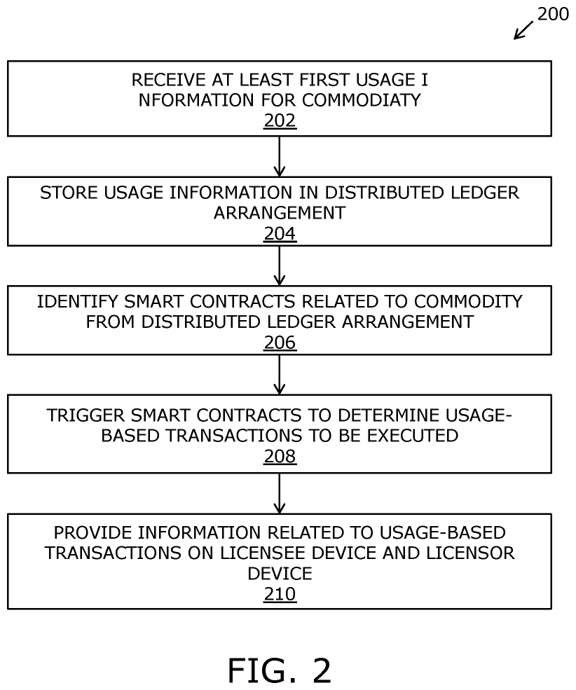

Referring to FIG. 2, illustrated are steps of a method for determining and executing usage-based transactions from a licensee to at least one licensor using smart contracts and a distributed ledger arrangement, in accordance with an embodiment of the present disclosure. The method is depicted as a collection of steps in a logical flow diagram, which represents a sequence of steps that can be implemented in hardware, software, or a combination thereof, for example as aforementioned.

The method for determining usage-based transactions from at least one licensee to at least one licensor using smart contracts and a distributed ledger arrangement is implemented via a system comprising a server arrangement communicably coupled to the distributed ledger arrangement. At a step 202, at least a first usage information of a commodity associated with the licensee is received. At a step 204, the usage information is stored in the distributed ledger arrangement. At a step 206, at least one smart contract relating to the commodity is identified from the distributed ledger arrangement. The smart contracts comprise licensing information and terms relating to usage of the commodity. At a step 208, the smart contract is triggered based on the usage information stored in the distributed ledger arrangement to determine the usage-based transactions to be executed. At a step 210, information related to the usage-based transactions are provided on at least one licensee device and at least one licensor device.

The steps 202, 204, 206, 208 and 210 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1-13. (canceled)

14. A system for determining usage-based transactions from at least one licensee to at least one licensor using smart contracts and/or a distributed ledger arrangement, wherein the system comprises at least one electronic commodity, a server arrangement communicably coupled to the distributed ledger arrangement, the server arrangement operable to:
receive at least a first usage information of an electronic commodity associated with the licensee;
store the usage information in the distributed ledger arrangement;
identify at least one smart contract relating to the commodity from the distributed ledger arrangement, wherein the smart contracts comprise licensing information and terms relating to usage of the commodity;
trigger at least one smart contract based on the usage information stored in the distributed ledger arrangement to determine the usage-based transactions, to be executed; and
provide information related to the usage-based transactions on at least one licensee device and at least one licensor device.

15. A system of claim 14, wherein the server arrangement executes the usage-based transactions on the licensee device and at least one licensor device.

16. A system of claim 14, wherein the smart contract is stored in the distributed ledger arrangement upon receiving approval, relating to licensing information and terms, from the licensee and at least one licensor.

17. A system of claim 14, wherein the commodity is any kind of electronic device that can directly or indirectly connect to the distributed ledger arrangement.

18. A system of claim 17, wherein the server arrangement is operable to receive usage information of one or more components of the electronic device upon use thereof and execute a secondary smart contract relating to the one or more components.

19. A system of claim 14, wherein the distributed ledger arrangement is a private distributed ledger arrangement.

20. A method for determining usage-based transactions from at least one licensee to at least one licensor using a distributed ledger arrangement, wherein the method is implemented via a system comprising at least one electronic commodity, a server arrangement communicably coupled to the distributed ledger arrangement. The method comprising:
receiving at least a first usage information of a commodity associated with the licensee;
storing the usage information in the distributed ledger arrangement;
identifying at least one smart contract relating to the commodity from the distributed ledger arrangement, wherein the smart contracts comprise licensing information and terms relating to usage of the commodity;
triggering at least one smart contract based on the usage information stored in the distributed ledger arrangement for determining the usage-based transactions, to be executed; and
providing information related to the usage-based transactions on a licensee device and at least one licensor device.

21. A method of claim 20, wherein the method comprises executing the usage-based transactions on at least one licensee device and at least one licensor device.

22. A method of claim 20, wherein the method comprises storing the smart contract in the distributed ledger arrangement upon receiving approval, relating to licensing information and terms, from at least one licensee and at least one licensor.

23. A method of claim 20, wherein the commodity is an electronic device that can directly or indirectly connect to the distributed ledger arrangement.

24. A method of claim 23, wherein the method comprises receiving usage information of one or more components of the electronic device upon use thereof and executing a secondary smart contract relating to the one or more components.

25. A method of claim 20, wherein the distributed ledger arrangement is a private distributed ledger arrangement.

26. A computer program product comprising non-transitory computer-readable storage media having computer-readable instructions stored thereon, the computer-readable instructions being executable by a computerized device comprising processing hardware to execute a method of claim 20.
